(19) United States
(12) Patent Application Publication
(10) Pub. No.: US 2013/0143198 A1
(43) Pub. Date: Jun. 6, 2013

(54) BLOOD PLASMA LYOPHILIZATION PROCESS

(71) Applicant: Anne Sailliol, Chatenay Malabry (FR)

(72) Inventor: Anne Sailliol, Chatenay Malabry (FR)

(73) Assignee: ETAT FRANCAIS (MINISTERE DE LA DEFENSE), SERVICE DE SANTE DES ARMEES, Armees (FR)

(21) Appl. No.: 13/817,290

(22) PCT Filed: Aug. 16, 2011
(86) PCT No.: PCT/FR2011/051919

§ 371 Date: Feb. 15, 2013

(30) Foreign Application Priority Data
Aug. 16, 2010 (FR) 1056619

(51) Int. Cl. A01N 1/02

(52) U.S. Cl. CPC A01N 1/0284
USPC 435/2

(57) ABSTRACT

The present invention relates to a lyophilized plasma, resulting from a mixture of plasmas originating from selected donors, which is virally attenuated and compatible with all blood groups and to the process for obtaining same.

The present invention relates to a leukodepleted lyophilized plasma which is virally attenuated, free of hemolyzing antibodies and compatible with all blood groups, and to the process for obtaining same.

“Blood plasma” or “plasma” is the liquid component of blood, in which the blood cells are in suspension. Plasma can be separated from whole blood by centrifugation or filtration through a membrane. Blood plasma consists essentially of water, plasma proteins (mainly albumin and antibodies) and coagulation factors, including fibrinogen.

Blood plasma is used in therapy for treating serious coagulopathies with collapse of all the coagulation factors and also for treating acute hemorrhages, with overall coagulation factor deficiency.

Currently, therapeutic plasma is virally attenuated fresh frozen plasma (FFP). Such a plasma requires storage at a temperature of less than or equal to −25° C., which implies that its administration can be carried out only after thawing under specific conditions. Furthermore, this type of plasma cannot be stored for more than a year, which creates sizable losses. Finally, this therapeutic plasma must be used with care since its administration must observe the rules of delivery based on recipient ABO compatibilities. Because of the restrictions linked to its use and to its storage and therefore its availability, such a fresh frozen plasma proves to be unsuitable for application under emergency conditions, in particular at the time of military battles.

There is therefore a need for a plasma which complies with the operational constraints of the armed forces on external theaters of operation, which can be stored at ambient temperature, which is free of any form of bacterial, viral or parasitic contamination and which is compatible with any recipient independent of the ABO blood group thereof.

Following lengthy and thorough research, the inventors have developed a process for preparing a lyophilized plasma, the characteristics of which meet such storage and use requirements.

Thus, the invention relates to a process for preparing attenuated lyophilized plasma comprising the following steps:
a) selecting leukodepleted and physicochemically attenuated unit plasmas;
b) mixing the selected unit plasmas; and
c) lyophilizing said mixture of plasmas.

The process of the invention makes it possible, ultimately, to obtain a “lyophilized plasma” or “freeze-dried plasma”, by virtue of an appropriate lyophilization step. The plasma obtained after reconstitution of the lyophilized plasma in a take-up solvent meets the regulatory requirements to which the plasmas currently used in therapy are subject, in particular the concentrations of coagulation factors are satisfactory (for example, the concentration of factor VIII is greater than or equal to 0.5 IU/ml) and there is no activation of coagulation.

The term “unit plasma” is intended to mean plasma collected from a single donor individual. This unit plasma can be prepared from whole blood or be collected by apheresis. Preferentially, in the context of this invention, the unit plasmas constituting the mixture of plasmas of step b) of the process of the invention are collected by apheresis. This unit plasma is placed in a plasma bag. Generally, these bags contain between 200 and 250 ml of unit plasma. Preferentially, the unit plasmas constituting the mixture of plasmas of step b) comply with the same regulatory requirements to which the plasmas currently used in therapy are subject. They therefore observe the requirements in force, particularly in terms of hemostasis factor levels. The donor individuals must therefore observe the regulatory criteria for plasma donation eligibility. Preferentially, the unit plasmas are obtained from male donors or donors free of anti-HLA antibodies. In addition, in the context of the present invention, the donors must exhibit hemostasis test results which are normal and characterized by a factor VIII level at least equal to 0.9 IU/ml.

The term “donor individual” is intended to mean an individual capable of donating his blood or blood components.

The term “mixture of plasmas” or “transfusion batch” is intended to mean a mixture of unit plasmas.

The term “whole blood” is intended to mean all the compounds and cells making up the blood.

The term “apheresis” is intended to mean a technique for taking a sample of certain blood components from a donor. The components which it is desired to sample are separated by centrifugation and stored, while the components not sampled are reinjected into the donor.

In one particular embodiment, the unit plasmas constituting the mixture of plasmas of step b) of the process according to the invention are obtained from at most ten different donor individuals. Such a limitation with regard to the number of donor individuals makes it possible to considerably reduce the residual infectious risk while at the same time benefiting from the advantages of the mixture: reduced immunogenicity and obtaining of a universal plasma for blood grouping. It also enables simplified traceability of the donor individuals.

In another embodiment, the unit plasmas constituting the mixture of plasmas of step b) of the process according to the invention are obtained from at most twenty different donor individuals.

Preferentially, said donor individuals belong to blood group AB. Thus, the unit plasmas are selected in such a way that each of the plasmas used correspond to plasmas obtained from donor individuals belonging to blood group AB. The unit plasmas obtained from donor individuals belonging to this group are characterized by an absence of anti-A and anti-B agglutinins, which makes it possible to administer their plasma independent of the recipient's ABO blood group. This ideal situation is rarely possible owing to the rareness of donor individuals belonging to blood group AB. Thus, in one particular embodiment of the invention, said donor individuals are characterized in that at least one of said donor individuals belongs to blood group A and that at least one of said donor individuals belongs to the blood group B and in that the volume of plasma obtained from the donor individual(s) belonging to blood group A is identical to the volume of plasma obtained from the donor individual(s) belonging to blood group B.

Thus, the unit plasmas can be selected in such a way that, among the individuals donating the unit plasmas, some belong to the blood group A, others to blood group B and, optionally, others to blood group AB. In any event, the volume of plasma obtained from the donor individuals belonging to blood group A is identical to the volume of plasma obtained from the donor individuals belonging to blood group B.

For example, the unit plasmas constituting the mixtures of plasmas of step b) of the process can be collected from donor individuals, the blood groups of which are the following:
4 donor individuals belonging to blood group A;
4 donor individuals belonging to blood group B; and
2 donor individuals belonging to blood group AB.

In this particular base, it is advisable to make sure that the volume of plasma obtained from the 4 donor individuals belonging to blood group A is identical to the volume of plasma obtained from the 4 individuals belonging to blood group B.

Thus, by virtue of the selection of the unit plasmas, the invention overcomes the drawback linked to the low number of donor individuals belonging to blood group AB, termed “universal plasma donors”, for obtaining a plasma that can be administered to any recipient individual, independently of the ABO blood group thereof.

In one particular embodiment, the mixture of plasmas of step b) of the process comprises:
20% to 50%, preferentially 30% to 50%, more preferentially 40% to 45% by volume of unit plasmas obtained from donor individuals belonging to blood group A;
20% to 50%, preferentially 30% to 50%, more preferentially 40% to 45% by volume of unit plasmas obtained from donor individuals belonging to blood group B; and
0 to 60%; preferentially 0 to 40%, more preferentially 10% to 20% by volume of unit plasmas obtained from donor individuals belonging to blood group AB.

The term “blood group” is intended to mean a classification of blood based on the presence or absence of antigenic substances on the surface of the red blood cells. These antigenic substances define the ABO system. The A antigen, or agglutinogen A, corresponds to an N-acetylgalactosamine. The B antigen, or agglutinogen B, corresponds to a galactose. The ABO system dictates the rules of compatibility for blood transfusion. Not observing these rules can lead to a hemolytic event in the individual transfused. Since the plasma contains antibodies according to the group in the ABO system, the red blood cells of the recipient must not exhibit the corresponding antigens. Thus, a plasma comprising anti-A agglutinins should not be administered to a patient belonging to blood group A, and vice versa. The plasma of donor individuals belonging to group AB does not contain anti-A or anti-B agglutinins and is thus suitable for all recipient individuals. The term “universal plasma donors” is therefore used.

The expression “individual belonging to blood group A, B or AB” is intended to mean an individual having, respectively, the phenotype A, B or AB.

The unit plasmas constituting the mixture of plasmas of step b) of the process of the invention are leukodepleted. The presence of leukocytes in transfused products can cause various adverse effects, such as the transmission of viruses, for example the cytomegalovirus. Leukodepletion also makes it possible to reduce the febrile reactions associated with antigen-antibody reactions in the HLA system. This leukodepletion, also known as “leukocyte reduction” or “leukoreduction” is carried out by filtration on the plasma collected by apheresis. Alternatively, this leukodepletion can be carried out by filtration on the plasma prepared from whole blood.

Preferentially, the unit plasmas constituting the mixture of plasmas of step b) are free of hemolyzing antibody. The absence of hemolyzing antibody can be carried out directly on the unit plasmas collected from the donor individual. Thus, the absence of hemolyzing antibody in the plasmas collected makes it possible to obtain a mixture of plasmas in step b) containing no hemolyzing antibody.

The “hemolyzing antibodies” or “hemolysins” are immunoglobulins G or IgG which can be found in the plasma and which are capable of lyzing red blood cells. The anti-A hemolysins are specific for red blood cells exhibiting agglutinogen A, while the anti-B hemolysins are specific for red blood cells exhibiting agglutinogen B. Their presence in a “universal” therapeutic plasma is unacceptable. The presence of such hemolyzing antibodies in the mixture of plasmas would make the product obtained by means of the process unsuitable for “universal” use in therapy. Thus, the unit plasmas constituting the mixture of plasmas of step b) of the process of the invention must not contain anti-A or anti-B hemolysins.

Preferentially, the unit plasmas constituting the mixture of plasmas of step b) are free of agglutinin. Typically, the plasmas not comprising agglutinins are plasmas obtained from individuals belonging to blood group AB.

Alternatively, the unit plasmas constituting the mixture of plasmas of step b) have an agglutinin titer of less than 64, preferentially less than 32, preferentially less than 16, preferentially less than 8, more preferentially less than 4. The determination of the antibody titer is well known to those skilled in the art. It involves establishing a series of dilutions of the plasma and carrying out the reaction for detecting agglutinins with each dilution. The highest dilution which still offers a positive reaction would give the titer. Thus, when, at a dilution of 1/32, the agglutinins to be titrated are still detected, but this detection no longer occurs at a dilution of 1/64, the agglutinin titer in this plasma is 32.

The agglutinins are IgM immunoglobulins present in the plasma and capable of agglutinating red blood cells. The anti-A agglutinins agglutinate red blood cells exhibiting agglutinogen A. The anti-B agglutinins agglutinate the red blood cells exhibiting agglutinogen B. The absence of agglutinins or the presence thereof at a low concentration in the mixture of plasmas obtained in step b) makes it possible, ultimately, to obtain a lyophilized plasma according to the process of the invention which may be used, after reconstitution, on any recipient, independently of the blood group thereof.

Preferentially, the mixture of plasmas of step b) of the process is free of irregular agglutinin. Irregular agglutinins are antibodies which may be present in plasma and which are directed against antigens present on the surface of red blood cells but which do not correspond to agglutinogens A or B.

The unit plasmas constituting the mixture of plasmas of step b) of the process of the invention are virally attenuated or made secure by physicochemical treatment.

The term “attenuation”, “viral attenuation” or “making secure” is intended to mean the elimination of pathogenic agents that may be present in the plasma. This viral attenuation or making secure destroys the majority of enveloped or nonenveloped pathogens or prevents the replication thereof.

In the context of this invention, the attenuation is carried out by physicochemical treatment of the unit plasmas, prior to the mixing thereof. Alternatively, this attenuation can be carried out on the mixture of plasmas obtained in step b). The attenuation by physicochemical treatment can be a treatment using a photochemical agent such as amotosalen or methylene blue, or a solvent-detergent treatment.

Preferentially, this attenuation is carried out using a photochemical agent such as amotosalen, methylene blue or riboflavin.

The term “pathogenic agent” is intended to mean a bacterial, viral or parasitic contaminant. The presence of such contaminants is unacceptable for the use of a plasma in therapy.

The term “attenuated plasma” or “virally attenuated plasma” is intended to mean a plasma which has undergone an attenuation step, i.e. the actual destruction or the inhibition of the replication of pathogenic agents such as bacterial, viral or parasitic contaminants.

In one particular embodiment, the unit plasmas constituting the mixture of plasmas of step b) of the process of the invention are attenuated via the action of a photochemical agent chosen from amotosalen, riboflavin and methylene blue. The use of such a photochemical agent involves exposure to a light source. When it is activated by light of an appropriate wavelength, the photochemical agent, also called photo-oxidizing agent, can directly destroy the bacterial or viral contaminant or else inhibit its ability to replicate. Such a plasma attenuation technique is particularly advantageous since it makes it possible to destroy any contaminant, including those which are not detectable by the conventional techniques of the prior art. The operating conditions which allow the elimination of pathogenic agents using a photochemical agent are known to those skilled in the art. Typically, this method is carried out according to a standardized protocol based on the use of a disposable device. The photochemical agent is added to the plasma. The plasma is then subjected to a light source. The final step consists in eliminating the traces of the residual photochemical agent and any possible degradation products thereof using a filter enabling their absorption. According to the invention, this technique for eliminating pathogenic agents is preferentially applied to each unit plasma collected by apheresis.

Preferentially, this photochemical agent is amotosalen. The elimination of pathogenic agents using amotosalen has the advantage of not causing too great a loss of coagulation factors present in the plasma, and quite particularly for fibrinogen (which plays an important role in hemostasis in an individual suffering from a hemorrhagic trauma) and factor VIII. Amotosalen is a psoralene derivative which reversibly intercalates at pyrimidine bases of single-stranded or double-stranded DNA or RNA molecules. Illumination with ultraviolet A light (380 to 400 nm) creates irreversible covalent bonds which interrupt the nucleic acids and block their replication, thus making it possible to reduce the bacterial, viral or parasitic load and to inhibit bacterial, viral or parasitic replication in the plasma before lyophilization. This agent is particularly effective for inactivating enveloped or nonenveloped viruses, Gram + and Gram − bacteria, spirochetes, spores, parasites and residual lymphocytes. Various studies have shown that this agent exhibits no risk of toxicity in the long term nor any risk of reproductive toxicity. It is not carcinogenic and exhibits no noticeable toxic effect. Typically, in order for the elimination of pathogenic agents to be effective, it is advisable to treat the unit plasmas with amotosalen at a concentration of between 100 and 200 μM, preferentially approximately 150 μM. After treatment of the unit plasmas, it is advisable to eliminate the residual traces of amotosalen. Those skilled in the art can carry out control tests for detecting the presence of residual amotosalen. This residual amotosalen concentration should preferentially not exceed 2 μM.

Preferentially, this photochemical agent is riboflavin. Riboflavin, or vitamin B2, is a nontoxic natural compound which, when it is used in combination with ultraviolet radiation, makes it possible to inactivate viruses, bacteria and parasites. Its use also makes it possible to neutralize the white blood cells present in certain blood constituents. Typically, riboflavin is used by means of the Mirasol device, sold by the company CaridianBCT. It is currently used for the treatment of platelets in suspension in plasma, and for the treatment of fresh frozen plasma. The inventors have shown that this system is also highly suitable for use in the context of the present invention.

The leukodepleted and attenuated unit plasmas can be frozen within 8 hours of the sample being taken from the donor individuals. The plasmas thus frozen are then stored at a temperature of less than or equal to −25° C. until the preparation of the mixture of these plasmas. These plasmas are then thawed before they are mixed together. Typically, the unit plasmas are thawed in a water bath at 37° C. Thus, step a) can be carried out in the following way:
i. collection of unit plasmas by apheresis;
ii. leukodepletion of said unit plasmas;
iii. physicochemical attenuation of said unit plasmas;
iv. deep-freezing of said unit plasmas within 8 hours following collection of the unit plasmas;
v. storage of said frozen unit plasmas at a temperature of less than or equal to −25° C.;
vi. thawing of the frozen unit plasmas, preferentially in a water bath at 37° C. for a period of less than 30 minutes, preferentially for a period of approximately 15 minutes.

According to one particular embodiment, the invention relates to a process for preparing attenuated lyophilized plasma comprising the following steps:
a) selecting leukodepleted and physicochemically attenuated unit plasmas by:
   i. collection of unit plasmas by apheresis,
   ii. leukodepletion of said unit plasmas,
   iii. physicochemical attenuation of said unit plasmas,
   iv. deep-freezing of said unit plasmas within 8 hours following collection of the unit plasmas,
   v. storage of said frozen unit plasmas at a temperature of less than or equal to −25° C.,
   vi. thawing of the frozen unit plasmas;
b) mixing the unit plasmas selected; and
c) lyophilizing said mixture of plasmas.

In one particular embodiment, the invention relates to a process for preparing secure lyophilized plasma, comprising the following steps:
A) selecting leukodepleted unit plasmas made secure with amotosalen and originating from donors having normal coagulation test results and a factor VIII level greater than 0.9 IU/ml, said plasmas being obtained from at most ten different donor individuals and said donors being chosen from male donors or donors free of anti-HLA antibodies;
B) mixing the unit plasmas selected; and
C) lyophilizing said mixture of plasmas.

The process of the invention comprises a step of mixing the unit plasmas. A “transfusion batch” is then obtained. The mixing of the unit plasmas is carried out at ambient temperature. Typically, the unit plasmas (contained in plasma bags) are mixed so as to obtain a transfusion batch with a volume of between 2000 and 10 000 ml, preferentially between 2500 and 9000 ml. In a first embodiment, this transfusion batch has a volume of between 2500 and 4000 ml, preferably approximately 3000 ml. In a second embodiment, this transfusion batch has a volume of between approximately 5000 and approximately 9000 ml, preferably approximately 6000 ml. A mixture of unit plasmas, the administration of which can be carried out independently of the blood group of the donor individual, is thus obtained.

Typically, the content of this transfusion batch is distributed into 500 ml glass infusion bottles. This distribution is carried out under sterile conditions. Each bottle then contains an amount of plasmas of from 200 to 250 ml, preferentially 215 ml. These bottles, which are referred to as “type I”, are characterized in that they are neutral and do not interact with their content. Thus, no reaction takes place between the bottle and the plasma that it contains. This type of bottle is suitable for the preparation of an injectable product. These bottles meet the requirements of the pharmacopeia and are readily commercially available.

The process of the invention comprises a step c) of lyophilizing the mixture of attenuated plasmas. This lyophilizing step is particularly tricky since it is advisable not to compromise the hemostatic properties of the mixture of attenuated plasmas. It is therefore advisable to control the equilibrium between a very low residual moisture content and the preservation of the coagulation factors, which can prove to be particularly sensitive to the aggressive lyophilization process. Typically, this lyophilizing step is carried out on type I bottles having a volume of 500 ml, containing the mixtures of plasmas as previously obtained. Typically, each bottle containing approximately 215 ml of plasmas is placed on a shelf of the lyophilizer.

Preferentially, lyophilizing step c) makes it possible to obtain a lyophilized plasma which has a moisture content of less than 2%, preferentially less than 1%.

Typically, the lyophilization of step c) comprises several phases: thawing, primary desiccation or sublimation, and secondary desiccation or final drying.

The term “lyophilization” or “freeze-drying” is intended to mean a low-temperature dehydration operation which consists in eliminating, by sublimation, most of the water contained in a product. It allows long-term storage through a reduction in the water activity of the product. Preferentially, in the context of this invention, the lyophilization comprises a rapid freezing phase at −50° C. in which the water contained in the plasma is solidified. Typically, this freezing step is carried out with a ramp lasting between 15 and 60 minutes, preferentially approximately 30 minutes, and a hold lasting between 100 and 600 minutes, preferentially approximately 300 minutes.

Next, there is the sublimation phase, also called primary desiccation, which will cause the water to go from the solid form to the vapor form, without going through a liquid form. This step is carried out at a pressure of less than 300 μBar and at a temperature of between 10 and 15° C. Typically, the first hold at 10° C. has a ramp lasting between 20 and 120 minutes, preferentially approximately 60 minutes and a hold lasting between 2000 and 4000 minutes, preferentially approximately 3000 minutes. The second hold at 15° C. has a ramp lasting between 5 and 60 minutes, preferentially approximately 10 minutes and a hold lasting between 800 and 2000 minutes, preferentially approximately 1200 minutes.

The final step, commonly called “final drying” or “secondary desiccation”, is the step which consists in removing the water, termed captive, from the product by desorption. The captive water corresponds to the water molecules which remain trapped at the surface of a product subjected to primary desiccation. This final drying step is carried out at a temperature between 30 and 35° C. at a reduced pressure of approximately 30 μBar. Typically, the first hold at 35° C. has a ramp lasting between 2000 and 15 000 minutes, preferentially 6000 minutes, and a hold lasting between 800 and 2000 minutes, preferentially 1200 minutes. The second hold at 30° C. has a ramp lasting between 2000 and 1000 minutes, preferentially 480 minutes, and a hold lasting between 1200 and 2500 minutes, preferentially 1800 minutes.

This lyophilization protocol and the particular conditions thereof make it possible to obtain a lyophilized plasma which has a moisture content of less than 2%, preferentially less than 1%.

The invention also relates to a lyophilized plasma which is compatible with all blood groups. Preferably, this lyophilized plasma is leukodepleted, attenuated and free of hemolyzing antibody so as to meet the regulatory requirements. The term “freeze-dried and secured plasma” (FDSP) or “lyophilized plasma” (FLYP: “French Lyophilized Plasma”) is used.

Preferentially, the lyophilized plasma of the invention is characterized in that it comprises a mixture of plasmas collected from donor individuals, at least one of whom belongs to blood group A and at least one of whom belongs to blood group B, and in that the volume of plasma obtained from the donor individual(s) belonging to blood group A is identical to the volume of plasma obtained from the donor individual(s) belonging to blood group B.

This lyophilized plasma has a moisture content of less than 2%, preferentially less than 1%. It is also characterized in that it can be stored at ambient temperature or in a refrigerated chamber at a temperature between 2° C. and 25° C. and for a period of three years, preferentially two years.

Preferentially, this lyophilized blood plasma is sterile. The invention also relates to a process for preparing reconstituted plasma comprising the step of reconstituting the attenuated, leukodepleted, lyophilized plasma which is free of hemolyzing antibody and compatible with all blood groups, in a take-up solvent. The reconstitution of the plasma thus makes it possible to obtain an injectable preparation which can be administered to any recipient under emergency conditions.

Typically, the reconstitution of the plasma is carried out in a volume of take-up solvent of between 100 and 400 ml, preferentially 200 ml. Typically, this reconstitution is carried out with a volume which makes it possible to obtain an iso-osmotic plasma.

Preferentially, this take-up solvent is water and more preferentially water for injection. Preferentially, the reconstitution of the lyophilized plasma so as to obtain an injectable preparation is carried out in a period of less than 6 minutes, preferentially less than 3 minutes.

Thus, the use of the plasma according to the invention is very advantageous and dispenses with the time required for thawing when frozen fresh plasma is used.

The invention also relates to an attenuated, leukodepleted, reconstituted plasma which is free of hemolyzing antibody and compatible with all blood groups. Such a reconstituted plasma can be administered to any individual independently of the blood group thereof. It is therefore highly suitable for use under emergency conditions, in particular in the field of military operations, but also in the civilian sector, for the treatment of hemorrhagic emergencies with coagulopathy, in particular in an isolated situation with logistical conditions which do not make it possible to control a negative cold chain. The reconstituted plasma according to the invention also has the advantage of destroying most pathogenic agents, which considerably reduces the potential transmission of pathogens to recipient individuals. This reconstituted plasma meets all the regulatory requirements to which the plasmas used in therapy are subject.

Preferentially, the reconstituted plasma according to the invention is free of hemolyzing antibody.

Preferentially, the reconstituted plasma according to the invention is free of agglutinin. Alternatively, the reconstituted plasma according to the invention has an agglutinin titer of less than 64, preferentially less than 32, preferentially less than 16, preferentially less than 8, and more preferentially less than 4.

Preferentially, the reconstituted plasma according to the invention is free of irregular agglutinin.

The reconstituted plasma of the invention is characterized in that the concentration of factor VIII is greater than 0.2 IU/ml, preferentially greater than 0.5 IU/ml, preferentially greater than 0.7 IU/ml, more preferentially greater than 0.9 IU/ml and even more preferentially between 0.5 and 1.5 IU/ml.

The reconstituted plasma of the invention is characterized in that the concentration of factor V is greater than 0.15 IU/ml, and preferentially between 0.7 and 1.2 IU/ml. The international units (IU) for coagulation factors express the plasma activity of the proteins to which this expression is applied. One international unit (IU) of these plasma proteins corresponds to the amount of this factor contain in one ml of normal human plasma.

The reconstituted plasma of the invention is characterized in that the concentration of fibrinogen is greater than 1 g/l and more preferentially between 2 and 4 g/l.

The reconstituted plasma of the invention is characterized in that it is sterile and nonpyrogenic.

Finally, the invention relates to a kit comprising:
a) lyophilized plasma according to the invention;
b) a suitable amount of take-up solvent, preferentially water for injection; and
c) an instruction leaflet.

In one particular embodiment, said kit also comprises:
d) a clinical and biological follow-up sheet which falls within the framework of active hemovigilance; and
e) a technical sheet for implementing the traceability of the plasma according to the invention.

Preferentially, this lyophilized plasma is in a form suitable for use in the theater of military operations and in very isolated environments with logistic difficulties for controlling a negative cold chain.

### FIGURE LEGEND

FIG. 1: Analysis of the hemoglobin, platelet and fibrinogen level, before and after infusion of reconstituted lyophilized plasma according to the invention in soldiers on the field of military operations.
Ns: means not significant

FIG. 2: Analysis of the prothrombin level (TP) before and after infusion of reconstituted lyophilized plasma according to the invention.

### EXAMPLES

### Example 1

### Lyophilization of a Mixture of Plasmas

a) Selection of Unit Plasmas

Approximately 200 ml of plasma are recovered by apheresis from donor individuals belonging to blood groups A, B and AB.

Each donor individual can donate 2 or 3 bags of plasma at each donation, but this donation can be used more than once to make up the mixture. Thus, each donor can give from approximately 400 to approximately 1800 ml of plasma.

At the time of the plasma collection, said unit plasmas are leukodepleted by filtration.

Said unit plasmas are then attenuated using amotosalen. To do this, each of the bags of unit plasma is supplemented with 15 ml of amotosalen at a concentration of 150 μM. The plasmas comprising the amotosalen are subjected to illumination with ultraviolet A light (380 to 400 nm) for 5 to 10 minutes. After treatment, the amotosalen is removed by filtration on an absorbent resin.

Said attenuated unit plasmas are then deep-frozen within 8 hours following the collection of the plasmas. This step then makes it possible to store said plasmas at a temperature of −25° C.

15 minutes before mixing the plasmas, the plasmas to be thawed are placed in a water bath at 37° C.

b) Mixtures of the Unit Plasmas Selected

6 mixtures of plasmas M1 to M6, also called transfusion batches, are prepared. Each of the mixtures M1 to M6 corresponds to a mixture of plasmas obtained from individuals belonging to blood groups A, B and AB. For example, for the mixture M1, the following are used:
6 bags of plasmas (1327 ml of plasma) obtained from 3 different donor individuals belonging to blood group A,
6 bags of plasmas (1339 ml of plasma) obtained from 3 different donor individuals belonging to blood group B, and
2 bags of plasmas (445 ml of plasma) obtained from 2 different donor individuals belonging to blood group AB.

A mixture M1 comprising 3111 ml of plasmas is thus obtained.

The volume of the various plasmas used for these mixtures and the blood group distribution of the donor individuals for each of the mixtures M1 to M6 are given in detail in the table below:

TABLE 1
Blood group distribution of the donor individuals

| | Volume of plasma | Volume of plasma | Volume of plasma |
|---|---|---|---|
| | obtained from | obtained from | obtained from |
| | donor of | donor of | donor of |
| Mixture | phenotype A (ml) | phenotype B (ml) | phenotype AB (ml) |
| M1 | 1327 | 1339 | 445 |
| M2 | 1329 | 1336 | 445 |
| M3 | 1346 | 1352 | 437 |
| M4 | 1264 | 1258 | 638 |
| M5 | 1327 | 1338 | 442 |
| M6 | 1315 | 1327 | 442 |

6 transfusion batches comprising from 3000 to 3300 ml of plasmas are thus obtained.

c) Lyophilization Step

The mixtures of plasmas are distributed into 500 ml “type I” bottles, such that each of the bottles contains 215 ml of the mixture of plasmas.

The lyophilization of the plasmas contained in each of the previously obtained bottles is carried out in an SMH 615 lyophilizer sold by Usifroid. Each bottle is placed on a shelf. The lyophilization is carried out under the specific conditions detailed below.

1. Pre-Cooling

This step makes it possible to cool the shelves of the lyophilizer to a temperature of −5° C. This step makes it possible to avoid degradation of the coagulation factors which are thermosensitive, during the distribution time. The batches are loaded into the lyophilizer as they are prepared.

2. Freezing

The mixture of plasmas is frozen at a temperature of −50° C. The product is maintained at this temperature for 240 minutes. The ramp lasts 30 minutes and the hold is 300 minutes.

3. Placing Under Vacuum

In order to enable the sublimation, the lyophilizer is placed under vacuum. The vacuum is drawn for 2 minutes at a pressure of 600 mBar.

4. Sublimation

This step is carried out at a temperature of between 10 and 15° C. and at a pressure of less than 300 μBar.

The first hold at a temperature of 10° C. has a ramp of 60 minutes and a hold of 3000 minutes.

The second hold with a temperature of 15° C. has a ramp of 10 minutes and a hold of 1200 minutes.

5. Secondary Desiccation

This step is carried out at a temperature of between 30 and 35° C. at a pressure of 30 μBar.

The first hold at 35° C. has a ramp of 600 minutes and a hold of 1200 minutes.

The second hold at 30° C. has a ramp of 480 minutes and a hold of 1800 minutes.

d) Lyophilizate Quality Controls

This protocol makes it possible to obtain a lyophilized plasma which has a relative moisture content of less than 2%.

### Example 2

### Reconstitution of the Lyophilized Plasmas

A 500 ml bottle of each of the transfusion batches M1 to M6 is taken. 200 ml of water for injection are added to each of these 6 bottles. 6 reconstituted plasmas PR1 to PR6 are thus obtained.

After reconstitution, the product obtained must meet the following requirements:
reconstitution time less than 6 minutes;
concentration of factor VIII greater than or equal to 0.5 IU/l;
absence of anti-A and anti-B hemolysins;
anti-A and anti-B agglutinin titer less than 64;
absence of irregular agglutinins; and
protein concentration greater than or equal to 50 g/L.

The composition and the characteristics of the plasmas thus reconstituted are detailed in the table below:

TABLE 2
Compositions and characteristics of the reconstituted plasmas

| | | | | | | | | Mean | Reference |
|---|---|---|---|---|---|---|---|---|---|
| Parameters | Units | PR 1 | PR 2 | PR 3 | PR 4 | PR 5 | PR 6 | factors | value |
| Fibrinogen | g/L | 2.55 | 2.18 | 2.49 | 2.95 | 2.18 | 2.69 | 2.5 | 2-4 |
| | | | | | | | | (2.2-3 ) | |
| Factor V | IU/ml | 0.42 | 0.43 | 0.58 | 0.81 | 0.41 | 0.51 | 0.53 | 0.7-1.2 |
| | | | | | | | | (0.418-0.81) | |
| Factor VIII | IU/ml | 0.65 | 0.53 | 0.57 | 0.72 | 0.52 | 0.71 | 0.62 | 0.5-1.5 |
| | | | | | | | | (0.52-0.72) | |
| Factor XI | IU/ml | 0.89 | 0.74 | 0.64 | 0.96 | 0.76 | 0.81 | 0.8 | 0.5-1.4 |
| | | | | | | | | (0.64-0.96) | |
| XIII | IU/ml | 1.24 | 1.12 | 0.89 | 1.12 | 0.95 | 1.08 | 1.06 | 0.2-1.2 |
| | | | | | | | | (0.89-1.24) | |
| Protein C | IU/ml | 1.09 | 0.9 | 1.02 | 0.89 | 0.83 | 0.88 | 0.94 | 0.7-1.2 |
| | | | | | | | | (0.89-1.09) | |
| Protein S | IU/ml | 0.64 | 0.56 | 0.79 | 1.14 | 0.7 | 0.74 | 0.76 | 0.7-1.4 |
| | | | | | | | | (0.56-1.14) | |
| Antithrombin III | IU/ml | 1.06 | 0.97 | 1.03 | 1.06 | 1.04 | 0.94 | 1 | 0.8-1.2 |
| | | | | | | | | (0.94-1.06) | |
| α2 antiplasmin | IU/ml | 0.94 | 0.98 | 0.92 | 1 | 0.97 | 0.96 | 0.96 | 0.8-1.2 |
| | | | | | | | | (0.91-1 ) | |
| TAT complexes | μg/L | 3.4 | 2.1 | 2.3 | 5.9 | 2 | 3.1 | 3.1 | 2-4.2 |
| | | | | | | | | (2-5.9) | |
| Fragments 1 + 2 | pM | 127 | 112 | 134 | 154 | 111 | 140 | 130 | 29-229 |
| Hemolysins | | Absence | Absence | Absence | Absence | Absence | Absence | Absence | Absence |
| Anti-A titer | | 16 | 16 | 2 | 4 | 4 | 8 | 8 | <64 |
| Anti-B titer | | 8 | 32 | 2 | 2 | 0 | 0 | 8 | <64 |
| Irregular | | Absence | Absence | Absence | Absence | Absence | Absence | Absence | Absence |
| agglutinins | | | | | | | | | |
| Total proteins | g/L | 55.1 | 60.2 | 61.6 | 58 | 60 | 61 | 59.3 | >50 |
| Protein | | Normal | Normal | Normal plot | Normal plot | Normal plot | Normal plot | Normal plot | Normal plot |
| electrophoresis | | plot | plot | | | | | | |
| Residual | μM | 0.78 | 0.75 | 0.85 | | | | 0.79 | <2 |
| amotosalen | | | | | | | | | |
| Moisture content | % | 1.15 | 0.58 | 0.22 | 1.91 | 1.29 | 1.17 | 1.05 | <2% |
| Reconstitution | sec | 125 | 270 | 205 | 145 | 140 | 130 | 169 | <360 |
| time | | | | | | | | | |

The criteria measured are in accordance with the regulatory requirements. The plasma obtained according to the process of the invention is therefore suitable for therapeutic use.

### Example 3

### Effect of the Lyophilization on Coagulopathies and Hemorrhages

The inventors administered the reconstituted lyophilized plasma according to the invention in the theater of military operations, to soldiers having suffered serious traumas such as injuries inflicted by firearms, after explosions or else after collisions.

Materials and Method

The soldiers given infusions were subjected to a blood analysis and a hemostasis analysis before and after the infusion of the reconstituted lyophilized plasma according to the invention.

The variables thus harvested were analyzed according to conventional statistical techniques, based on the Student's test, the Wilcoxon test or else the chi² test.

87 soldiers were given infusions of the lyophilized plasma according to the invention, including 32 victims of bullet wounds, 22 victims of polytrauma, 10 victims of explosions, 7 victims of head traumas and, finally, 4 victims of other types of injuries.

The data linked to this transfusion are recapitulated in the table below:

TABLE 3
Blood characteristics of transfused soldiers

| | | | Patient |
|---|---|---|---|
| Characteristics before | | | percentage |
| blood administration | Median | Rank | (%) |
| Erythrocytes (unit) | 3 | 1-13 | 32 |
| Whole blood (unit) | 4 | 1-7 | 5 |
| Crystalloid (L) | 1 | 0.2-5 | 56 |
| Colloid (ml) | 500 | 100-8000 | 15 |
| Factor VIIa (mg) | 2 | 1-7 | 9 |
| Fibrinogen (g) | 1.5 | 1-3 | 6 |

Results

The results are given in FIG. 1.

The differences in the hemoglobin, platelet and fibrinogen levels before and after transfusion prove to be nonsignificant. Thus, the inventors showed that the level of blood factors is unaffected and that the use of the plasma of the invention proves to be of no risk to the health of the soldier having undergone the infusion of said plasma.

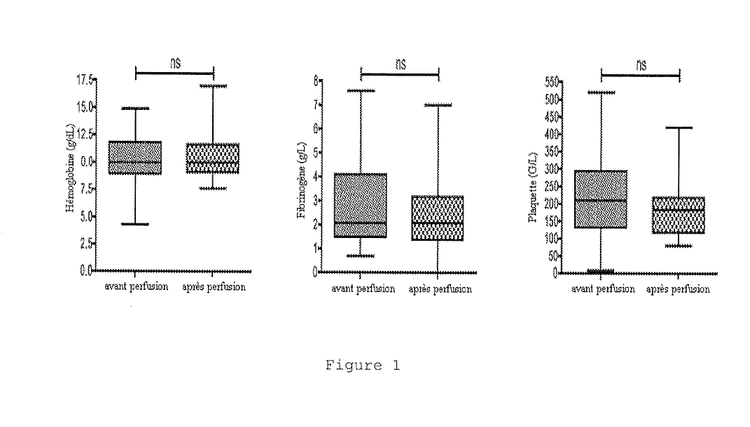

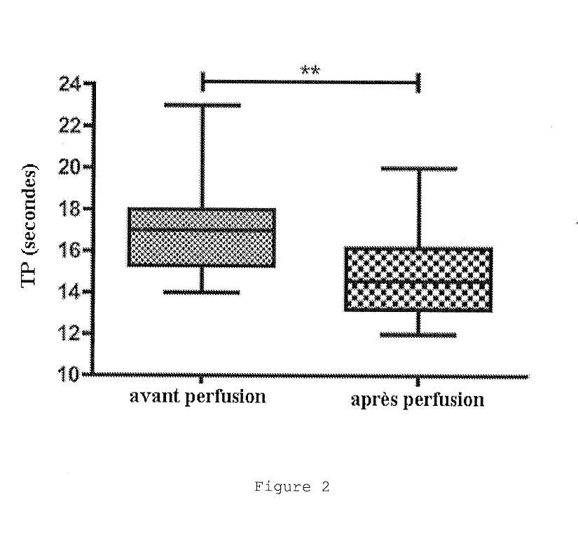

Furthermore, the inventors succeeded in showing that the lyophilized plasma according to the invention makes it possible to control coagulopathies in war injuries. In addition, the inventors demonstrated the fact that the infusion of lyophilized blood plasma of the invention makes it possible to reduce the prothrombin time, as shown in FIG. 2. These results indicate that the plasma of the invention is effective in the treatment of hemorrhages.

Finally, the results show that the lyophilized plasma according to the invention makes it possible to obtain excellent results with the major advantage of being able to be reconstituted in less than 6 minutes and of providing an amount of 210 ml of ready-to-use plasma. These results are, moreover, comparable to those that can be obtained with infusion of frozen fresh plasma.

### Example 4

### Use of the Lyophilized Plasma According to the Invention in the Treatment of Massive Hemorrhage

Many studies show that sizable and early infusion of plasma considerably improves the survival of soldiers during military operations. 63 soldiers were given an infusion of one to nine bags of plasma in accordance with the invention.

The inventors analyzed their blood before and after the infusion of said plasma. The results show that the prothrombin level went from 17 sec before said infusion to 15.6 seconds after said infusion.

This decrease indicates an improvement in hemostasis, which improvement may prove to be crucial prior to a surgical procedure.

The use of the reconstituted lyophilized plasma according to the invention showed no adverse effect.

### Example 5

### Effect of the Lyophilization on the Overall Hemostatic Capacities of the Reconstituted Lyophilized Plasma According to the Invention

The inventors studied the effect of the lyophilization on the quality of the plasma obtained and its effect on hemostasis.

Materials and Method

The inventors used 24 batches before and after lyophilization.

The inventors determined the level of fibrinogen and also of coagulation factors V, VIII, XI and XIII by means of colorimetric and chronometric assays. A thrombin generation test was also carried out. After dilution of the lyophilized plasma and of a standardized control, thromboelastography was then performed.

Finally, the blood of 17 healthy donors was 60% diluted:
60% of lactated Ringer's solution, or
30% of lactated Ringer's solution+30% of lyophilized plasma before lyophilization, or
30% of lactated Ringer's solution+30% FDP after lyophilization.
   Finally, thromboelastography was carried out.

Result

The results obtained after lyophilization are summarized below:
a decrease of approximately 22% to 26% in the activity of factor VIII and factor V (0.6 IU/ml±0.1);
a decrease of approximately 10% in the level of protein S (0.8 IU/ml±0.2);
no decrease in the activity of fibrinogen (2.4 g/L±0.2), of factor X (0.8 IU/ml±0.1), of factor XIII (1 IU/ml±0.1), of protein C (0.9 IU/ml±0.1) and of alpha2-antiplasmin (1 IU/ml±0.1);
no modification of thrombin generation; and
no coagulation factor activation.

The inventors also showed that, after dilution, the lyophilization does not induce any modification in the thromboelastogram parameters.

These quantitative and qualitative results indicate that the overall hemostasis capacities of the lyophilized plasma are preserved, in comparison with the nonlyophilized plasma.

1. A process for preparing attenuated lyophilized plasma comprising the following steps:
a) selecting leukodepleted and physicochemically attenuated unit plasmas;
b) mixing the unit plasmas selected; and
c) lyophilizing said mixture of plasmas;
characterized in that said unit plasmas constituting the mixture of plasmas of step b) are obtained from at most ten different donor individuals.

2. The process as claimed in claim 1, characterized in that said donor individuals belong to blood group AB.

3. The process as claimed in claim 1, characterized in that at least one of said donor individuals belongs to blood group A and that at least one of said donor individuals belongs to blood group B and in that the volume of plasma obtained from the donor individual(s) belonging to blood group A is identical to the volume of plasma obtained from the donor individual(s) belonging to blood group B.

4. The process as claimed in claim 1, characterized in that unit plasmas constituting the mixture of plasmas of step b) are free of hemolyzing antibody.

5. The process as claimed in claim 1, characterized in that the unit plasmas constituting the mixture of plasmas of step b) have an agglutinin titer of less than 64.

6. The process claimed in claim 1, characterized in that the unit plasmas constituting the mixture of plasmas of step b) are attenuated via the action of a photochemical agent chosen from amotosalen, methylene blue and riboflavin.

7. The process as claimed in claim 1, characterized in that the unit plasmas constituting the mixture of plasmas of step b) are attenuated by the action of amotosalen.

8. The process as claimed in claim 1, characterized in that the lyophilizing step c) makes it possible to obtain a lyophilized plasma which has a moisture content of less than 2%.

9. A process for preparing reconstituted plasma comprising the step of reconstituting the plasma obtained by means of the process as defined in claim 1 in a take-up solvent for injection.

10. A lyophilized plasma which is compatible with all blood groups, characterized in that it comprises a mixture of plasmas collected from donor individuals, at least one of whom belongs to blood group A and at least one of who belongs to blood group B and in that the volume of plasma obtained from the donor individual(s) belonging to blood group A is identical to the volume of plasma obtained from the donor individual(s) belonging to blood group B.

11. A process for preparing virally attenuated lyophilized plasma, comprising the following steps:
A) selecting leukodepleted unit plasmas virally attenuated with amotosalen, said plasmas being obtained from at most ten different donor individuals and said donors having normal hemostasis test results and a factor VIII level greater than 0.9 IU/ml, and being chosen from male donors or donors free of anti-HLA antibodies;
B) mixing the unit plasmas selected; and
C) lyophilizing said mixture of plasmas.
